(19) United States
(12) Patent Application Publication
(10) Pub. No.: US 2015/0319204 A1
(43) Pub. Date: Nov. 5, 2015

(54) TECHNIQUE FOR COMMUNICATION IN A COMMUNICATION NETWORK CENTERED ON INFORMATION

(71) Applicant: ORANGE, Paris (FR)

(72) Inventors: Wei You, Xi'an (CN); Bertrand Mathieu, Bodou (FR)

(21) Appl. No.: 14/651,204

(22) PCT Filed: Dec. 17, 2013
(86) PCT No.: PCT/FR2013/053143

§ 371 Date: Jun. 10, 2015

(30) Foreign Application Priority Data
Dec. 18, 2012 (FR) 1262260

(51) Int. Cl. H04L 29/06

(52) U.S. Cl. CPC H04L 65/4069; H04L 65/1096

(57) ABSTRACT

The invention relates to a technique for communication implemented by a routing device in a communication network implementing a name-based routing. To process a request relating to a segment of data of a given stream to be routed, the routing device obtains (E8) at least one identifier of an interface by way of which at least one other segment of data of said given stream has been routed during the processing of an earlier request relating to said other segment of data and routes (E9) this request by way of this at least one interface obtained. In a particular embodiment, a stream being attached to a domain, the request is also routed (E10) by way of another interface through which at least one other segment of data of a stream attached to said domain has been received.

The invention relates to a communication technique in an information-centered communication network, implementing name-based forwarding.

The article by Van Jacobson et al., entitled “Networking Named Content” and published in 2009 in the proceedings of the CoNEXT'09 conference, presents a new content-centered architecture, called “Content-Centric Networking”. This architecture proposes to change the current communication model based on addressing of equipment in the network by a new communication model employing name-based addressing of contents. More generally, a new ICN (for “Information Centric Networking”) architecture is in the course of definition, to allow name-based addressing for the streams forwarded in this type of network.

A stream can be supplied for different applications, real time or not, and is identified in the communication network by a stream name or identifier. A stream is made up of data segments. For its part, a data segment is identified by a segment number and the stream identifier.

More specifically, to obtain a data segment of a stream, a client entity transmits a request relating to this data segment, called “Interest Packet”. On receipt of this request, a forwarding device verifies whether it has the data segment sought in a cache memory or content store. If such is the case, it then transmits it to the interface by way of which the request was received, thus destined for the client entity, if appropriate by way of other forwarding devices. If it does not have the data segment sought, it checks in a pending requests table PIT (Pending Interest Table) to see if it has already transmitted a request relating to the same data segment. If such is not the case, it stores, in the pending requests table PIT, the identifier of the data segment sought in association with an identifier of the interface via which the request relating to the data segment sought was received. It determines thereafter on the basis of a forwarding table (the so-called “Forwarding Information Base”, FIB) and as a function of the stream identifier an interface by way of which it transmits the request. In the converse case, that is to say when the pending requests table already contains the identifier of the data segment sought, it does not transmit the request received but associates, in the pending requests table PIT with the identifier of the data segment sought, an identifier of the interface via which the request was received. When the forwarding device receives the data segment sought, it retransmits it on the set of interfaces by way of which requests relating to this data segment have been received, with final destination the set of client entities that requested it. The forwarding device can also store it in its cache memory, so as to more rapidly distribute the data segment in response to a subsequent request of another client entity. Each forwarding device implements its own rules for managing its cache memory.

One of the aims of the invention is to remedy inadequacies/drawbacks of the prior art and/or to provide enhancements thereto.

According to a first aspect, the subject of the invention is a communication method implemented by a device for forwarding in a communication network implementing name-based forwarding. This method comprises the following steps implemented to process a request relating to a data segment of a given stream, said request having to be forwarded by way of an interface of the forwarding device:

a first step of obtaining at least one identifier of an interface by way of which at least one other data segment of said given stream has been forwarded during the processing of an earlier request relating to said other data segment;
a first step of forwarding said request by way of said at least one interface obtained.

Applications transmit data segments relating to a stream. These are for example applications such as real-time content broadcasting services, on demand or even “live”. They can also be telephony applications. There is no limitation as to the type of application.

Such data segments can be objects or even pieces of objects or even packets.

The communication network is a content- or information-centered network. It thus implements name-based forwarding and aggregates requests relating to a data segment of a stream. The data segment requests sent by one or more client entities are received from forwarding devices linked to this or these client entities and transmitted to other devices for forwarding to an item of equipment having the data segment sought. The data segments are for their part received from this item of equipment by way of forwarding devices and retransmitted to the requesting client entity or entities by way of forwarding devices if necessary.

A request or enquiry relating to a data segment is said to require to be forwarded when the pending requests table does not comprise any identifier of the data segment, that is to say no request is in progress or pending for this data segment.

Thus, by virtue of the invention, the communication method allows a forwarding device to invoke other forwarding devices liable to have the data segment sought in their content store or cache memory. Such an other forwarding device is liable to have this data segment in its content store because it has previously requested the relevant device for this data segment or another data segment of this stream and has received it from the latter. This makes it possible to decrease the time required for the forwarding of the data segment.

The various embodiments or characteristics mentioned hereinbelow can be added, independently or in combination with one another, to the steps of the communication method as defined previously.

According to a particular characteristic, a stream being attached to a domain, the method comprises a second step of obtaining an identifier of another interface by way of which at least one other data segment of a stream attached to said domain has been received and a second step of forwarding the request by way of said other interface.

It is thus possible to invoke other forwarding devices having already provided data segments for this domain. This allows better targeting of the forwarding devices to be invoked. This also avoids having to implement mechanisms of publication in the network which relate to the location of the streams.

In a first particular embodiment, the second obtaining and forwarding steps are executed in parallel with the first obtaining and forwarding steps.

In a second particular embodiment, the second obtaining and forwarding steps are executed when the data segment has not been received in response to the first forwarding step.

According to a particular characteristic, the interface by way of which the data segment has been forwarded is stored in association with an identifier of said stream.

The method thus utilizes the information stored in the pending requests table and used to forward a data segment to dynamically construct a stream-based forwarding table, reflecting the location of the data segments of the stream in forwarding devices close to the forwarding device concerned in the network.

According to another particular characteristic, an identifier of the data segment comprising an item of information relating to a domain name, the interface by way of which the data segment is received is stored in association with the item of information relating to a domain name.

The method thus utilizes the information associated with the reception of a data segment to dynamically construct a domain-based forwarding table, reflecting the location of the streams in the network.

According to a second aspect, the invention also relates to a device for forwarding in a communication network implementing name-based forwarding, comprising the following means, activated to process a request relating to a data segment of a given stream, said request having to be forwarded on a link of the forwarding device:

a module for obtaining at least one identifier of an interface by way of which at least one other data segment of said given stream has been forwarded during the processing of an earlier request relating to said other data segment;
a module for forwarding said request by way of said at least one interface obtained.

The advantages stated in respect of the method according to the first aspect are directly transposable to the forwarding device.

In a particular embodiment, the forwarding device furthermore comprises a module for obtaining an identifier of another interface, a stream being attached to a domain, at least one other data segment of a stream attached to said domain having been received by way of said other interface.

According to a third aspect, the invention further relates to a communication network, comprising a forwarding device as described previously.

The advantages stated in respect of the method according to the first aspect are directly transposable to the communication network.

According to a fourth aspect, the invention relates to a program for a forwarding device, comprising program code instructions intended to control the execution of the steps of the method previously described, when said program is executed by said device, and to a recording medium that can be read by a forwarding device on which a program for a forwarding device is recorded.

The advantages stated in respect of the method according to the first aspect are directly transposable to the program for a forwarding device and to the recording medium.

According to a fifth aspect, the invention also relates to a communication method implemented by a device for forwarding in a communication network implementing name-based forwarding, said method comprising the following steps implemented to process a request relating to a data segment of a given stream, said request having to be forwarded by way of an interface of the forwarding device, a stream being attached to a domain:

a first step of obtaining an identifier of an interface by way of which at least one other data segment of a stream attached to said domain has been received; and
a second step of forwarding the request by way of said interface.

According to a sixth aspect, the invention also relates to a device for forwarding in a communication network implementing name-based forwarding, comprising the following means, activated to process a request relating to a data segment of a given stream, said request having to be forwarded on a link of the forwarding device:

a module for obtaining an identifier of an interface, a stream being attached to a domain, at least one other data segment of a stream attached to said domain having been received by way of said other interface;
a module for forwarding said request by way of said at least one interface obtained.

The invention will be better understood using the following description of particular embodiments of the method of the invention, with reference to the attached drawings in which:

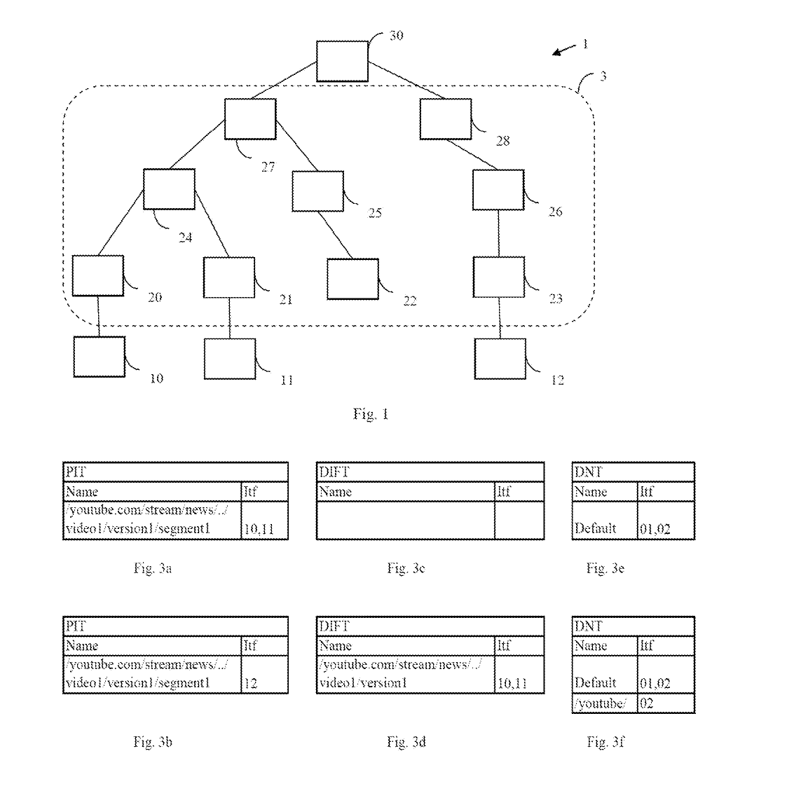

FIG. 1 represents an information-centered communication network;

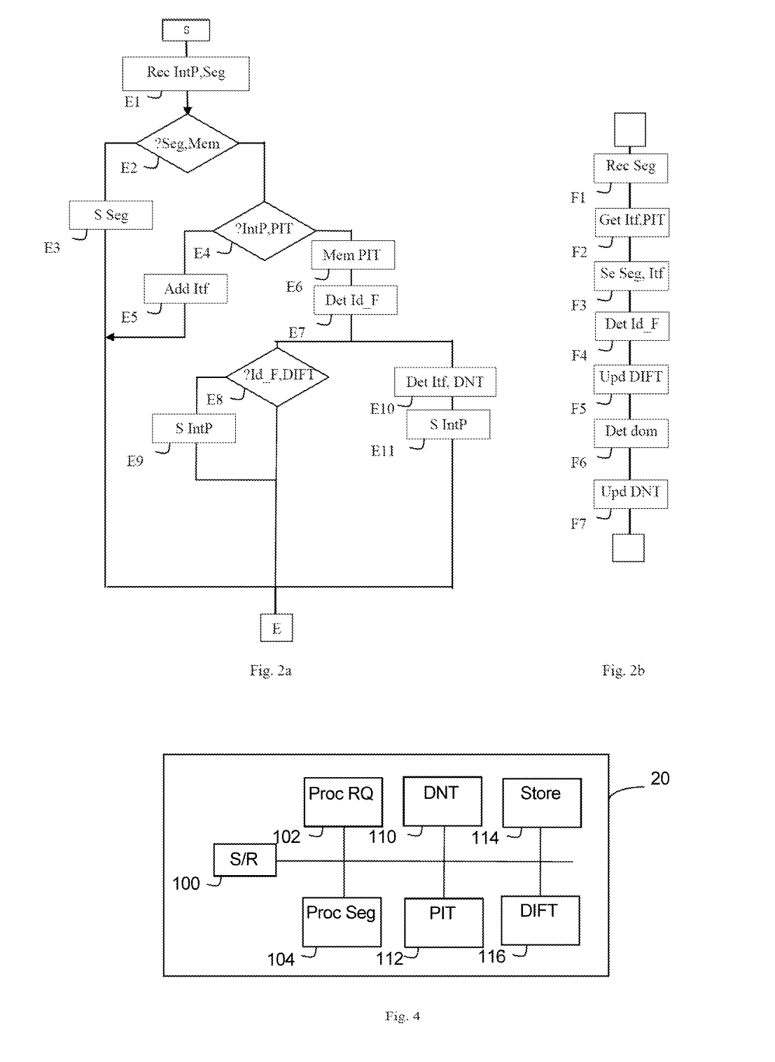

FIGS. 2a and 2b represent steps of the method according to a particular embodiment of the invention;

FIGS. 3a-3f represent tables used by a forwarding device for the implementation of the method in an illustrative example;

FIG. 4 represents a forwarding device according to a particular mode of the invention.

FIG. 1 represents a communication network 1 enabling client entities 10, 11, 12 to access different applications such as television, video on demand, and the Internet. Each client entity 10, 11, 12 is linked to an access network 3. The latter allows the client entities to access the applications implemented by servers, one of which, the server 30, is represented in FIG. 1.

When a client entity 10-12 accesses a given application implemented by the server 30, data segments relating to this given application are exchanged from the server 30 to the client entity 10-12. Such data segments can be objects or even pieces of objects or even packets.

It can concern browsing on a website comprising data segments. It can also concern a content broadcasting application, for example in an architecture of CDN (Content Delivery Network) type.

Hereinbelow, the particular case will be taken in which the communication network 1 is centered on information ICN, for “Information-Centric Networking”. As a nonlimiting example, the communication network implements name-based addressing mechanisms, such as those described in the article by Van Jacobson et al., entitled “Networking Named Content”, mentioned previously. Such a communication network is also called content-centered network CCN (Content Centric Network). As represented in FIG. 1, the devices are organized in the form of a tree. A stream is attached in the organization of the network to a domain. By way of nonlimiting example, a stream identifier Id_F is organized in the following manner:

a prefix or item of information relating to a domain name, corresponding to a forwardable or mutable name, for example “youtube.com”,

a name in the organization, for example “stream/news/ . . . /video1/version1”.

A data segment belonging to a stream is identified by the identifier of the stream and an item of information relating to the segment number.

According to this example, the data segment is identified “/youtube.com/stream/news/ . . . /video1/version1/segment1”.

More specifically, a client entity 10 transmits one or more requests relating to data segments. In the particular case where the server 30 has these data segments, it transmits them destined for the client entity 10. The data segments then travel by way of the access network 3 destined for the client entity.

The access network 3 comprises forwarding devices 20-28. These forwarding devices 20-28, one of which, the forwarding device 20, is represented in FIG. 4, comprise in particular in this type of communication network three data structures:

a first table 110, called domain-based forwarding table DNT (or “Domain Name Table”), designed to store data for forwarding the requests relating to data segments, more precisely a list of interface identifiers in association with a prefix;

a second table 112, called pending requests table PIT, standing for “Pending Interest Table”, designed to store a list of interfaces via which one or more requests relating to a data segment of a stream have been received, as long as this data segment has not been received in response (the request then being pending);

storage means 114 or cache memory, also called content store, designed to store data segments;

a third table 116, called second stream-based forwarding table DIFT (or “Dynamic Interest Forwarding Table”), designed to store data for forwarding the requests relating to data segments as a function of the stream, more precisely at least one identifier of an interface by way of which a data segment of this stream has been forwarded during the processing of an earlier request relating to this data segment in association with a stream identifier.

The storage means 114 are for example a memory area, a buffer area (or “buffer”) or else an external hard disk.

Such a forwarding device can be a router of the network, a network access gateway, an access multiplexer element.

As represented in FIG. 1, the client entity 10 is linked to the forwarding device 20. The client entity 11 is linked to the forwarding device 21. The forwarding devices 20 and 21 are linked to the forwarding device 24. The forwarding device 22 is linked to the forwarding device 25. The forwarding devices 24 and 25 are linked to the forwarding device 27. The client entity 12 is linked to the forwarding device 23, which is itself linked to the forwarding device 26, linked to the forwarding device 28. The forwarding devices 27 and 28 are linked to the server 30. It is stressed here that this is an illustrative example and that no limitation is attached to this representation.

We shall now describe the communication method, as it is implemented by the forwarding device 24 in a first particular embodiment, in relation to FIGS. 2a and 2b.

The particular case is considered where the client entity 10 wishes to obtain a data segment of a stream. The client entity 10 transmits an IntP (for “Interest Packet”) request relating to this data segment. The mechanism for propagating this request in the communication network 1 is defined subsequently.

FIG. 2a describes the steps of the communication method which are implemented by the forwarding device 24 to process a request D relating to a data segment.

In a step E1, the forwarding device 24 receives this request D.

In a step E2, the forwarding device 24 determines whether it has the data segment requested in its content store 114.

If such is the case, in a step E3, the data segment is forwarded to the interface by way of which the request D has been received.

In the converse case, that is to say that the data segment sought is not stored in the content store 114, in a step E4, the forwarding device 24 then uses the pending requests table 112 to check whether it has already transmitted a request of another client entity relating to this same data segment.

If such is the case, in a step E5, the forwarding device 24 adds to the pending requests table an identifier of the interface by way of which it has received the request, in association with an identifier of the data segment sought. The forwarding device 24 reverts thereafter to standby awaiting receipt of a request or of a data segment.

If it has not yet transmitted any request relating to this data segment, in a step E6, the forwarding device 24 stores in the pending requests table 112 the identifier of the data segment in association with an identifier of the interface by way of which it has received the request. Such a request D relating to a data segment is said to require to be forwarded by the forwarding device 24, that is to say that no request relating to this data segment has been transmitted as output from the device or is on standby awaiting a response.

In a step E7, the forwarding device 24 determines a stream identifier on the basis of the identifier of the data segment.

In a step E8, the forwarding device 24 determines whether this data segment or another data segment of this stream has been forwarded during the processing of an earlier request relating to this data segment or to this other data segment and, if appropriate, obtains one or more interface identifiers by way of which this forwarding has been performed. It thus entails an interface by way of which a request relating to this data segment or to another data segment of this same stream has been received and by way of which the data segment or the other data segment has been transmitted. More precisely, the forwarding device 24 performs this determination on the basis of the stream-based forwarding table 116. If such forwarding has been performed, the stream-based forwarding table 116 then comprises one or more interface identifiers in association with an identifier of the stream.

When the stream-based forwarding table 116 comprises an identifier of the stream, in a forwarding step E9, the forwarding device 24 forwards the request D to the interface or interfaces obtained. It is thus noted that the request D is forwarded to other forwarding devices liable to have the data segment sought in their own content store. Indeed, each forwarding device implements its own rules for managing its content store. It may for example implement a rule for deleting the least requested contents of the oldest contents, or else randomly selected contents. Thus, at each level in the network, the content stores will store different data segments. Forwarding the request D to an interface making it possible to reach another device that previously requested the forwarding device 24 for a data segment of the same stream and that has received it from the latter thus makes it possible to use the information stored in the content store of this other device. It is recalled here that, in the schemes known from the prior art, the request D is forwarded solely to an interface discovered by a routing protocol and stored in a forwarding table FIB.

On completion of this step E9 and also when the stream-based forwarding table 116 does not comprise the identifier of the stream, the communication method reverts to a standby step awaiting receipt of a request or of a data segment.

In parallel with steps E8 and E9, in a step E10, the forwarding device 24 determines an identifier of another interface by way of which this data segment or at least one other data segment of a stream of the same domain has been received. More precisely, the forwarding device determines an item of information relating to a domain name on the basis of the identifier of the data segment and obtains one or more interface identifiers on the basis of this item of information relating to the domain name. In the embodiment described, the forwarding device 24 obtains this or these interface identifiers on the basis of the first domain-based forwarding table 110.

In a step E11, the forwarding device 24 forwards the request by way of this or these other interfaces to one or more forwarding devices.

The forwarding device 24 reverts thereafter to standby awaiting receipt of a request or of a data segment.

On completion of these steps E7 to E11, the processing of the request D to be forwarded is terminated, the request to be forwarded having been transmitted to one or more interfaces for output to forwarding devices having previously requested the forwarding device 24 for at least one data segment of the stream and having received it from the latter and to forwarding devices having previously transmitted at least one data segment of the same domain in response to a request.

FIG. 2b describes, for its part, the steps of the communication method which are implemented to process a data segment received by way of an interface.

In a step F1, the forwarding device 24 receives the data segment.

In a step F2, the forwarding device 24 determines with the aid of the pending requests table 112 one or more interface identifiers to which the data segment must be forwarded. The data segment can also be stored in the content store 114.

In a step F3, the forwarding device 24 dispatches the data segment by way of the interface or interfaces determined.

In a step F4, the forwarding device 24 determines an identifier of the stream on the basis of the identifier of the data segment received.

In a step F5, the forwarding device 24 stores in the stream-based forwarding table 116 the interface or interfaces by way of which the data segment has been forwarded in association with the stream identifier determined.

When the data segment has been received by way of an interface determined with the aid of the first domain-based forwarding table 110, in a step F6, the forwarding device 24 determines an item of information relating to a domain name on the basis of the identifier of the data segment received. In a step F7, the forwarding device 24 stores in the first domain-based forwarding table 110 the interface by way of which has been received the data segment in association with the item of information relating to a domain name. When the first table already comprises an interface associated with this item of information relating to the domain name, this association is updated by addition of the interface.

The forwarding device 24 reverts thereafter to standby awaiting receipt of a request or of a data segment.

Steps F2 to F7 correspond to the processing of a data segment received.

Upon initialization of the method, the first domain-based forwarding table 110 contains default forwarding information defined for example by an operator of the communication network. This forwarding information is very general. It is noted that the first domain-based forwarding table 110 is enriched in the course of the execution of the communication method by storing the interfaces by way of which data segments of streams attached to the same domain are received. This makes it possible to dispatch a request to be forwarded to one or more interfaces by way of which a data segment of a stream of the same domain has been received and not to invoke the other devices. This also makes it possible not to require mechanisms for broadcasting in the communication network, making it possible to publish paths toward a device having a stream.

The second stream-based forwarding table 116 is also enriched in the course of the execution of the communication method and makes it possible to invoke forwarding devices that are closer in the topology of the communication network. These forwarding devices have previously transmitted to the relevant device a request relating to a data segment of the stream and have received it from the latter. This second stream-based forwarding table comprises more precise information than the first forwarding table since the stream identifiers are stored therein. The in-parallel implementation of the two forwarding steps E9 and E11 furthermore makes it possible to decrease the time required for the reception of the data segment.

In the embodiment described above, the forwarding steps E9 and E11 are performed in parallel. In a second embodiment, the forwarding step E11 is performed when no data segment has been received in response to the forwarding step E9. In a step subsequent to the forwarding step E9, the forwarding device 24 is on standby awaiting receipt of the data segment sought. When the data segment is received, the communication method thereafter passes to a processing of this data segment, described above. The reception of the data segment is for example supervised with the aid of a timeout. In the absence of reception of the data segment, the forwarding device 24 then implements step E10 and determines an identifier of another interface by way of which at least one other data segment of a stream of the same domain has been received. The forwarding device 24 then implements the forwarding step Ell and forwards the request by way of this or these other interfaces to one or more devices having previously transmitted at least one data segment of a stream of the same domain. The advantages mentioned previously in respect of the first embodiment in relation to the first and second forwarding tables are also obtained. The loading of the network is decreased in this second embodiment.

In a third embodiment, only the first domain-based forwarding table is provided for. The communication method does not then comprise steps E7, E8 and E9, and steps F4 and F5. The advantages mentioned previously in respect of the first embodiment in relation to this domain-based forwarding table are also obtained.

In a fourth embodiment, a forwarding table FIB, known from the prior art, and the second stream-based forwarding table 116 are provided for. Such a forwarding table FIB comprises forwarding data obtained by a routing protocol. Step E10 is then replaced with a step of determining one or more output interfaces on the basis of the forwarding table FIB. The advantages mentioned previously in respect of the first embodiment in relation to the stream-based forwarding table are also obtained.

By way of illustration, the forwarding tables 110, 116 and the pending requests table 112 are represented in FIGS. 3a-3f. In this example, the network is organized in the form of a tree and the forwarding device considered comprises three interfaces to downstream devices in the tree, with identifiers 10, 11, 12, and two interfaces to upstream devices in the tree, with identifiers 01, 02.

Upon initialization, as represented in FIG. 3e, the first domain-based forwarding table 110 or DNT comprises a default forwarding rule. The latter indicates that any request relating to a data segment and to be forwarded is transmitted by way of the two interfaces to upstream devices, that is to say to the interfaces 01, 02.

The second stream-based forwarding table 116 or DIFT represented in FIG. 3c is empty. First and second requests relating to the data segment of identifier “/youtube.com/stream/news/ . . . /video1/version1/segment1” have been received (step E1) and stored (step E6—for the first request—and step E5'for the second request—) in the pending requests table 112 or PIT, represented in FIG. 3a. The first request is forwarded (step E11) to the upstream interfaces 01, 02 using the default forwarding rule stored in the first domain-based forwarding table 110.

Subsequently, the data segment sought is received (step F1) by way of the interface 02. With the aid of the information stored in the pending requests table 112 (step F2), the data segment received is retransmitted (step F3) by way of the interfaces 10, 11. The identifier of the stream “/youtube.com/stream/news/ . . . /video1/version1” is stored in the second stream-based forwarding table DIFT (step F5) in association with the interfaces 10, 11, as represented in FIG. 3d. The item of information relating to a domain name “/youtube.com/” is stored in the first domain-based forwarding table DNT (step F7) in association with the interface 02, as represented in FIG. 3f.

A third request relating to this same data segment is received by way of the interface 12. The particular case is considered where the device considered no longer has the data segment in its content store 114. This third request is stored (step E6) in the pending requests table, as represented in FIG. 3b. The identifier of the stream being stored (step E8) in association with the interfaces 10, 11 in the second stream-based forwarding table DIFT (FIG. 3d), the third request is transmitted (step E9) by way of the two interfaces 10, 11 destined for the downstream devices. The data segment is liable to be stored in the content stores of these downstream devices, since they have previously requested the device considered for the data segment and have received the latter from it. The third request is also transmitted (step E11) by way of the interface 02 determined by virtue of the first domain-based forwarding table DNT (step E10; FIG. 30 to an upstream device. For a fourth request relating to another data segment of this same stream, the manner of operation is identical.

This simple example illustrates the manner of operation of the communication method, in particular the way in which the forwarding tables fill. It is thus noted that the first domain-based forwarding table DNT fills by analysis of the data segments received in response to requests and that the second stream-based forwarding table DIFT is filled as a function of the earlier transmissions of data segments to devices that have transmitted requests relating to data segments of the same stream. The second table thus makes it possible to improve the search for a data segment by invoking other devices than those making it possible to reach the item of equipment making the stream available.

Moreover, mechanisms are also implemented so as to delete obsolete data from the first and second forwarding tables. By way of example, the information stored in these forwarding tables can be deleted in a random manner. Still by way of example, a duration of validity, reinitialized when processing a data segment received by way of each stored interface, is associated with this interface.

We shall now describe a forwarding device in a particular embodiment of the invention with reference to FIG. 4. Such a device 20 is designed to process data segments belonging to various streams and comprises:

the first domain-based forwarding table 110 DNT described previously;
the pending requests table 112 PIT described previously;
the storage means 114 or content store described previously;
the second stream-based forwarding table 116 DIFT described previously;
a module for communication 100 with the other devices of the communication network, designed to send and receive data, in particular requests relating to data segments belonging to a stream and data segments;
a module 102 for processing requests relating to data segments in relation to the pending requests table 112, designed in particular to determine whether a request relating to a data segment is already pending and if appropriate to update the pending requests table and to forward a request by virtue of forwarding data;
a module 104 for processing data segments, designed to transmit the data segments destined for the client entities having requested them by virtue of the pending requests table 112 and by way of other forwarding devices.

The module 102 is in particular designed to determine an identifier of the stream on the basis of the identifier of the data segment sought and to obtain from the second stream-based forwarding table 116 at least one identifier of an interface by way of which at least one other data segment of this stream has been forwarded during the processing of an earlier request relating to this other data segment.

The module 102 is also designed to determine an item of information relating to a domain name on the basis of the identifier of the data segment sought and to obtain from the first domain-based forwarding table 110 at least one identifier of an interface by way of which at least one other data segment of a stream of this domain has been received.

The module 104 is in particular designed to store in the first domain-based forwarding table 110 at least one interface by way of which a data segment has been received in association with an item of information relating to a domain name for this data segment and to store in the second stream-based forwarding table 116 at least one identifier of an interface by way of which the data segment has been transmitted in association with an identifier of the stream to which this data segment belongs.

In a particular embodiment, the forwarding device 20 comprises only a single forwarding table, the first domain-based forwarding table 110. In this embodiment, the module 102 is designed to determine an item of information relating to a domain name on the basis of the identifier of the data segment sought and to obtain from the first domain-based forwarding table 110 at least one identifier of an interface by way of which at least one other data segment of a stream of this domain has been received. The module 104 is then designed to store in the first domain-based forwarding table 110 at least one interface by way of which a data segment has been received in association with an item of information relating to a domain name for this data segment.

In a particular embodiment, the forwarding device 20 comprises a forwarding table FIB, known from the prior art, and the second stream-based forwarding table 116. Such a forwarding table FIB comprises forwarding data obtained by a routing protocol. In this embodiment, the module 102 is in particular designed to determine an identifier of the stream on the basis of the identifier of the data segment sought and to obtain from the second stream-based forwarding table 116 at least one identifier of an interface by way of which at least one other data segment of this stream has been forwarded during the processing of an earlier request relating to this other data segment. The module 102 is also designed to obtain from the forwarding table FIB at least one identifier of an interface by way of which the request relating to a data segment must be retransmitted. The module 104 is in particular designed to store in the second stream-based forwarding table 116 at least one identifier of an interface by way of which the data segment has been transmitted in association with an identifier of the stream to which this data segment belongs.

The invention is implemented by means of software and/or hardware components. In this regard, the term “module” can correspond in this document either to a software component, or to a hardware component or to a set of hardware and/or software components, able to implement a function or a set of functions, according to what is described previously in respect of the module concerned.

A software component corresponds to one or more computer programs, one or more subprograms of a program, or more generally to any element of a program or of an item of software. Such a software component is stored in memory and then loaded and executed by a data processor of a physical entity and is liable to access the hardware resources of this physical entity (memories, recording media, communication buses, electronic input/output cards, user interfaces, etc.).

In the same manner, a hardware component corresponds to any element of a hardware set. It may or may not be a programmable hardware component, with or without integrated processor for the execution of software. It is for example an integrated circuit, a chip card, an electronic card for the execution of firmware, etc.

In a particular embodiment, the modules 102, 104 are designed to implement the method described above. These preferably entail software modules comprising software instructions for executing the steps of the above-described method and implemented by the forwarding device. The invention therefore relates also to:

a program for a forwarding device, comprising program code instructions intended to control the execution of the steps of the method described previously, when said program is executed by said device;
a recording medium that can be read by a forwarding device on which the program for a forwarding device is recorded.

The software modules can be stored in or transmitted by a data medium. The latter can be a hardware storage medium, for example a CD-ROM, a magnetic diskette or a hard disk, or else a transmission medium such as an electrical, optical or radio signal, or a telecommunication network.

The invention relates also to a communication network comprising at least one forwarding device as described previously.

7,5

1. A communication method implemented by a device (20-28) for forwarding in a communication network (1) implementing name-based forwarding, said method comprising the following steps implemented to process a request relating to a data segment of a given stream, said request having to be forwarded by way of an interface of the forwarding device:
a first step of obtaining (E8) at least one identifier of an interface by way of which at least one other data segment of said given stream has been forwarded during the processing of an earlier request relating to said other data segment;
a first step of forwarding (E9) said request by way of said at least one interface obtained.

2. The communication method as claimed in claim 1, in which, a stream being attached to a domain, said method comprises a second step of obtaining (E10) an identifier of another interface by way of which at least one other data segment of a stream attached to said domain has been received and a second step of forwarding (E11) the request by way of said other interface.

3. The communication method as claimed in claim 2, in which the second obtaining and forwarding steps are executed in parallel with the first obtaining and forwarding steps.

4. The communication method as claimed in claim 2, in which the second obtaining and forwarding steps are executed when the data segment has not been received in response to the first forwarding step.

5. The communication method as claimed in claim 1, in which the interface by way of which the data segment has been forwarded is stored (F5) in association with an identifier of said stream.

6. The communication method as claimed in claim 2, in which, an identifier of the data segment comprising an item of information relating to a domain name, the interface by way of which the data segment is received is stored (F7) in association with the item of information relating to a domain name.

7. A device (20-28) for forwarding in a communication network implementing name-based forwarding, comprising the following means, activated to process a request relating to a data segment of a given stream, said request having to be forwarded on a link of the forwarding device:
a module (102) for obtaining at least one identifier of an interface by way of which at least one other data segment of said given stream has been forwarded during the processing of an earlier request relating to said other data segment;
a module (100) for forwarding said request by way of said at least one interface obtained.

8. The forwarding device as claimed in claim 7, furthermore comprising a module (104) for obtaining an identifier of another interface, a stream being attached to a domain, at least one other data segment of a stream attached to said domain having been received by way of said other interface.

9. A communication network comprising at least one forwarding device as claimed in claim 7.

10. A program for a forwarding device, comprising program code instructions intended to control the execution of the steps of the method as claimed in claim 1, when said program is executed by said device.

11. A recording medium that can be read by a forwarding device on which the program as claimed in claim 10 is recorded.

12. The program as claimed in claim 10, in which, a stream being attached to a domain, said method comprises a second step of obtaining (E10) an identifier of another interface by way of which at least one other data segment of a stream attached to said domain has been received and a second step of forwarding (E11) the request by way of said other interface.

13. The program as claimed in claim 12, in which the second obtaining and forwarding steps are executed in parallel with the first obtaining and forwarding steps.

14. The program as claimed in claim 12, in which the second obtaining and forwarding steps are executed when the data segment has not been received in response to the first forwarding step.

15. The program as claimed in claim 10, in which the interface by way of which the data segment has been forwarded is stored (F5) in association with an identifier of said stream.

16. The program as claimed in claim 12, in which, an identifier of the data segment comprising an item of information relating to a domain name, the interface by way of which the data segment is received is stored (F7) in association with the item of information relating to a domain name.
